(19) United States
(12) Patent Application Publication
(10) Pub. No.: US 2006/0001376 A1
(43) Pub. Date: Jan. 5, 2006

(54) Plasma display panel

(76) Inventors: Satoshi Ginno, Yamanashi-ken (JP); Takahiro Togashi, Yamanashi-ken (JP); Shingo Iwasaki, Yamanashi-ken (JP); Yoshihiko Uchida, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/170,737

(22) Filed: Jun. 30, 2005

(30) Foreign Application Priority Data
Jul. 1, 2004 (JP) 2004-195804

(51) Int. Cl. H01J 17/49

(52) U.S. Cl. 313/582

(57) ABSTRACT

A row electrode in a row electrode pair has a bus electrode extending in the row direction and transparent electrodes each facing a transparent electrode in its counterpart row electrode in each discharge cell. The opposing portions of the transparent electrodes facing each other across a discharge gap are inclined at a required angle either in the clockwise direction or the counterclockwise direction relative to the row direction of the panel. The transparent electrodes with the opposing portions inclined in opposite directions are arranged in alternate positions along the associated bus electrodes and the transparent electrodes with the opposing portions inclined in the same direction face each other.

### BACKGROUND OF THE INVENTION

1. Field of the Invention

This invention relates to a panel structure of a surface-discharge-type alternating-current plasma display panel.

The present application claims priority from Japanese Application No. 2004-195804, the disclosure of which is incorporated herein by reference.

2. Description of the Related Art

In a typical plasma display panel (hereinafter referred to as “PDP”), as here described, a plurality of row electrode pairs and a plurality of column electrodes are provided between a pair of substrates disposed opposite each other across a display space. The row electrode pairs each extend in a row direction (the right-left direction of the panel surface) and are regularly arranged in a column direction (the vertical direction of the panel surface). Each of the column electrodes extends in the column direction so as to form discharge cells within the discharge space in positions corresponding to the respective intersections with the row electrode pairs. An address discharge is produced selectively between the column electrode and one of the row electrode pair. In each of the discharge cells selected through the address discharge, a sustaining discharge is produced between the row electrodes constituting a row electrode pair. The sustaining discharge results in light emission from a phosphor layer formed between the pair of substrates, thus generating an image in accordance with the image data of a video signal.

A breakdown voltage for the sustaining discharge produced to generate the image on PDP rises if the length of an area in which a discharge is initiated between the row electrodes constituting a row electrode pair facing each other on either side of a discharge gap (i.e. discharge-gap length) is short.

A requirement for a reduction in the breakdown voltage for the sustaining discharge to reduce the electric power consumption of the PDP is a maximum increase in the discharge-gap length of the area in which a discharge is initiated between the row electrodes.

However, the higher definition screen of a PDP in recent years involves a reduction in the area of each discharge cell accompanied by a decrease in the width of each discharge cell in the row direction. This gives rise to the disadvantage of the difficulty in setting the area in which a sustaining discharge is produced between the row electrodes, at a sufficient length for a reduction in the breakdown discharge.

The PDP shown in FIG. 1 has been developed for overcoming such a disadvantage.

In the conventional PDP shown in FIG. 1, the front glass substrate (not shown) serving as the display surface of the PDP has the back-facing face provided with a plurality of row electrode pairs (X, Y) each extending in the row direction (the right-left direction in FIG. 1) of the front glass substrate and arranged parallel to each other in the column direction.

Each of the row electrodes X and Y constituting a row electrode pair (X, Y) is composed of a metallic bus electrode Xa (Ya) extendingin the row direction of the front glass substrate and transparent electrodes Xb (Yb) regularly spaced from each other and connected to the bus electrode Xa (Ya) in such a manner as to extend out from the bus electrode Xa (Ya) in the column direction (the vertical direction in FIG. 1) toward its counterpart row electrode Ya (Xa).

Each of the transparent electrodes Xb (Yb) is formed in an approximate T shape made up of a narrow base end Xb1 (Yb1) extending in the column direction and connected to the bus electrode Xa (Ya) and a broad opposing portion Xb2 (Yb2) formed integrally with the leading end of the base end Xb1 (Yb1).

The opposing portion Xb2 (Yb2) of each transparent electrode Xb (Yb) is inclined at a predetermined angle in one direction (the counterclockwise direction in the example shown in FIG. 1) relative to the row direction of the front glass substrate, and confronts the opposing portion Yb2 (Xb2) of the counterpart transparent electrodes Yb (Xb) with a discharge gap g in between.

Reference symbol P in FIG. 1 denotes a partition wall unit for partitioning the discharge space defined between the front glass substrate and the back glass substrate (not shown) into discharge cells C each corresponding to the paired transparent electrodes Xb and Yb.

Such a conventional PDP is disclosed in Japan unexamined patent publication 2000-195431, for example.

The PDP produces an address discharge selectively between the transparent electrode Yb of the row electrode and the column electrode (not shown) formed on the back glass substrate. Then, a sustaining discharge is produced between the opposing portions Xb2 and Yb2 of the transparent electrodes Xb and Yb of the row electrodes X and Y which face each other across the discharge gap g.

The PDP is designed such that the opposing portions Xb2 and Yb2 of the transparent electrodes Xb and Yb between which the sustaining discharge is produced are inclined in one direction relative to the row direction. Because of this design, even if a reduction in the width of the discharge cell C in the row direction is required in the case of the higher resolution panel, the length of the discharge gap between the opposing portions Xb2 and Yb2 of the transparent electrodes Xb and Yb can be increased in correspondence with the inclination so as to be set at a length suitable for a reduction in the breakdown voltage of the sustaining discharge.

However, this conventional PDP has another problem as follows.

The opposing portions Xb2, Yb2 of the transparent electrodes Xb, Yb of the PDP are inclined in one direction. As a result, one end of the opposing portion Xb2 of the transparent electrode Xb in the transparent electrode pair (Xb, Yb) facing each other across the discharge gap g, and one end of the opposing portion Yb2 of the transparent electrode Yb in the adjacent transparent electrode pair (Xb, Yb) on the immediate left-hand side thereof in FIG. 1 are positioned to face each other, thus shortening a distance d between the ends of the opposing portions Xb2 and Yb2 in adjacent pairs.

In consequence, due to the close distance between the ends of the opposing portions Xb2 and Yb2 of the adjacent transparent electrode pairs (Xb, Yb), a capacitance is produced in a portion other than the opposing area between the transparent electrode Xb and Yb in a discharge cell when a potential difference is generated for the sustaining discharge between the row electrodes X and Y. The charging and discharging of the capacitance gives rise to the problem of an increase in consumption of reactive power which does not contribution to light emission.

### SUMMARY OF THE INVENTION

It is an object of the present invention to solve the problems associated with the conventional PDP as described above.

To attain this object, a PDP according to the present invention has a pair of substrates facing each other across a discharge space; a plurality of row electrode pairs each extending in a row direction and regularly arranged in a column direction on one of the pair of substrates; a plurality of column electrodes each extending in the column direction and regularly arranged in the row direction on either one or the other substrate in the pair of substrates; and unit light emitting areas formed in portions of the discharge space corresponding to intersections between the column electrodes and the row electrode pairs. In the PDP, each of row electrodes constituting the pair of row electrodes has: an electrode body extending in the row direction; and electrode projecting portions each extending out from the electrode body toward its counterpart row electrode, to face the electrode projecting portion of its counterpart row electrode across a discharge gap in each unit light emitting area. Each of the paired electrode projecting portions facing each other has a portion facing the other electrode projecting portion in the pair with the discharge gap in between, and the portion is inclined at a predetermined angle in either the clockwise direction or the counterclockwise direction relative to the row direction of the panel. The electrode projecting portions each having the portion facing the other electrode projecting portion in the pair and inclined in the clockwise direction, and the electrode projecting portions each having the portion inclined in the counterclockwise direction are placed in alternate positions along the associated electrode bodies, and the electrode projecting portions of one row electrode and the other row electrode in each row electrode pair are inclined in the same direction and face each other across the discharge gap.

In the best mode for carrying out the present invention, a PDP has column electrodes and row electrode pairs provided between a front glass substrate and a back glass substrate facing each other across a discharge space. Discharge cells are formed in positions in the discharge space corresponding to intersections between the column electrodes and the row electrode pairs. Each of the row electrodes constituting each of the row electrode pairs is composed of a bus electrode extending in the row direction and transparent electrodes connected to regularly spaced positions of the bus electrode and extending toward the bus electrode of its counterpart row electrode to face each other across a discharge gap. Each of the transparent electrodes is formed in either an approximately T shape or an approximately L shape made up of a base end that is connected to the bus electrode and extends in the column direction, and an opposing portion that is formed integrally with the leading end of the base end and extends with being inclined in either the clockwise direction or the counterclockwise direction relative to the row direction. The transparent electrodes having the opposing portions inclined in the clockwise direction and the counterclockwise direction are arranged in alternate positions along the bus electrode. The transparent electrodes in the row electrodes constituting the row electrode pair having the opposing portions inclined in the same direction face each other across the discharge gap.

In the PDP in the best mode, the opposing portions of the paired transparent electrodes which face each other across the discharge gap to provide for a sustaining discharge produced for light emission are inclined at a predetermined angle relative to the row direction. This makes it possible to set a longer discharge-gap length than the width of the discharge cell in the row direction in correspondence with the degree of inclination.

Accordingly, even if the higher definition of the panel involves a decrease in the width of the discharge cell in the row direction, it is possible to set a discharge-gap length suitable for a reduction in the breakdown voltage for the sustaining discharge.

The opposing portions of the opposing transparent electrodes are arranged along the associated bus electrodes in such a manner as to be alternately reversed in their inclining direction. For this reason, the distance between an opposing portion of a transparent electrode in a transparent electrode pair and an opposing portion of a transparent electrode adjacent to the other transparent electrode in the pair in the row direction is increased. Further, the ends of the transparent electrodes which are located in the adjacent discharge cells and to which different voltages are applied do not face each other.

In consequence, the capacity between the transparent electrodes located in adjacent discharge cells is reduced, leading to a reduction in the consumption of reactive power caused by charging and discharging the capacitance between the row electrodes.

These and other objects and features of the present invention will become more apparent from the following detailed description with reference to the accompanying drawings.

### BRIEF DESCRIPTION OF THE DRAWINGS

FIG. 1 is a front view illustrating the structure of a conventional PDP.

FIG. 2 is a schematic front view illustrating a first embodiment according to the present invention.

FIG. 3 is a sectional view taken along the V-V line in FIG. 2.

FIG. 4 is a schematic front view illustrating a second embodiment according to the present invention.

FIG. 5 is a schematic front view illustrating a third embodiment according to the present invention.

FIG. 6 is a schematic front view illustrating a fourth embodiment according to the present invention.

### DETAILED DESCRIPTION OF THE PREFERRED EMBODIMENTS

### First Embodiment

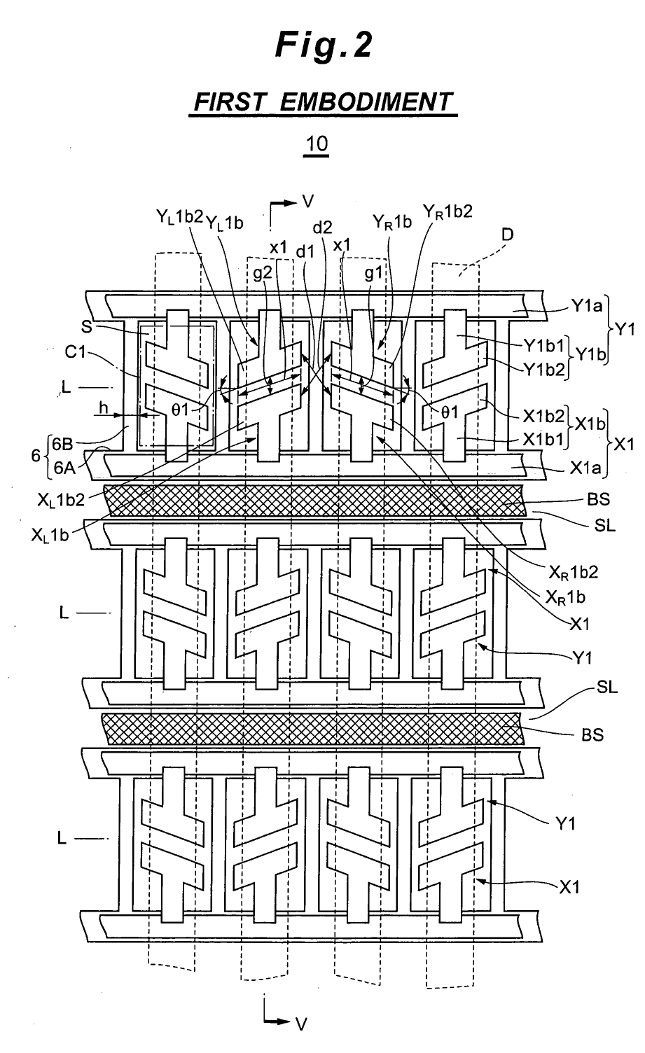

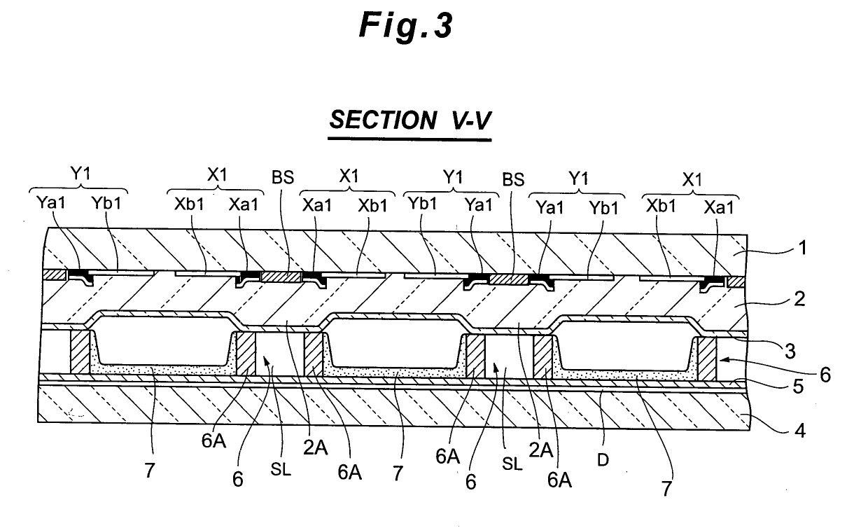

FIGS. 2 and 3 illustrate a first embodiment of a PDP according to the present invention. FIG. 2 is a schematic front view illustrating the structure of the PDP according to the first embodiment. FIG. 3 is a side sectional view taken along the V-V line in FIG. 2.

The PDP-10 in the first embodiment has, in FIGS. 2 and 3, a front glass substrate 1 serving as the display surface. A plurality of row electrode pairs (X1, Y1) each forming a display line L extend in the row direction (the right-left direction in FIG. 2) and are arranged parallel to each other in the column direction (the vertical direction in FIG. 2) on the back-facing face (the face facing toward the back of the PDP) of the front glass substrate 1.

The row electrode X1 constituting part of a row electrode pair (X1, Y1) is composed of a bus electrode X1 a which is formed of a metal film and extends in a bar shape in the row direction of the front glass substrate 1, and transparent electrodes X1b which are formed of a transparent conductive film made of ITO or the like and respectively extend out from regularly spaced portions of the bus electrode X1a toward the counterpart row electrode Y1 in the row electrode pair (X1, Y1).

The shape of the transparent electrode X1b will be described in detail later.

Similarly to the row electrode X1, the row electrode Y1 constituting part of a row electrode pair (X1, Y1) is composed of a bus electrode Y1a which is formed of a metal film and extends in a bar shape in the row direction of the front glass substrate 1, and transparent electrodes Y1b which are formed of a transparent conductive film made of ITO or the like and respectively extend out from the regularly spaced portions of the bus electrode Y1a toward the counterpart row electrode X1 in the row electrode pair (X1, Y1).

Each of the transparent electrodes X1b, Y1b of the row electrodes X1, Y1 is formed in an approximate T shape made up of a narrow base end X1b1 (Y1b1) extending in the column direction and connected to the bus electrode X1a (Y1a) and a broad opposing portion X1b2 (Y1b2) formed at the leading end of the base end X1b1 (Y1b1) and extending approximately in the row direction.

The opposing portions X1b2, Y1b2 of the transparent electrodes X1b, Y1b are each inclined at a predetermined angle θ1 in alternately opposite directions along the corresponding bus electrodes X1a, Y1a relative to the row direction.

More specifically, in each row electrode X1 and each row electrode Y1, transparent electrodes X1b, Y1b with the opposing portions X1b2, Y1b2 inclined to the right (in the clockwise direction) (hereinafter referred to as “transparent electrodes X_{R}1b, Y_{R1}b”), and transparent electrodes X1b, Y1b with the opposing portions X1b2, Y1b2 inclined to the left (in the counterclockwise direction) (hereinafter referred to as “transparent electrodes X_{L}1b, Y_{L}1b”) alternate in position in the row direction along the corresponding bus electrodes X1a, Y1a (see FIG. 2).

The opposing portions X_{R}1b2 and Y_{R}1b2 of the paired transparent electrodes X_{R}1b and Y_{R}1b face each other in parallel across a discharge gap g1. Likewise, the opposing portions X_{L}1b2 and Y_{L}1b2 of the paired transparent electrodes X_{L}1b and Y_{L}1b face each other in parallel across a discharge gap g2.

In the first embodiment, the row electrodes X1, Y1 of the row electrode pairs (X1, Y1) regularly arranged in the column direction alternate in position in the manner, X1-Y1, Y1-X1, X1-Y1 and so on in each display line L.

Black- or dark-colored light absorption layers (light shield layers) BS are formed on the back-facing face of the front glass substrate 1. Each of the light absorption layers BS extends in the row direction along and between back-to-back bus electrodes X1b and Y1b of the respective row electrode pairs (X1, Y1) adjacent to each other in the column direction.

A dielectric layer 2 is formed on the back-facing face of the front glass substrate 1 and covers the row electrode pairs (X1, Y1). Additional dielectric layers 2A protrude from the back-facing face of the dielectric layer 2. Each of the additional dielectric layers 2A extends in an area opposite to back-to-back bus electrodes X1a (Y1a) of the adjacent row electrode pairs (X1, Y1) and to the light absorption layer BS extending between these bus electrodes X1a (Y1a), and in parallel to the bus electrodes X1a, Y1a.

Further, an MgO protective layer 3 is formed on the back-facing faces of the dielectric layer 2 and the additional dielectric layers 2A.

The front glass substrate 1 is disposed parallel to the back glass substrate 4 with a discharge space S in between. Column electrodes D are formed on the front-facing face (the face facing toward the display surface) of the back glass substrate 4. Each of the column electrodes D extends in a direction at right angles to the row electrode pairs (X1, Y1) along an area opposite to paired transparent electrodes X1b and Y1b of the row electrode pairs (X1, Y1) (i.e. in the column direction). The column electrodes D are arranged parallel to each other at predetermined intervals.

A white-colored column-electrode protective layer 5 is formed on the front-facing face of the back glass substrate 4 and covers the column electrodes D. Partition wall units 6 are formed on the column-electrode protective layer 5.

Each of the partition wall units 6 is formed in an approximate ladder shape made up of a pair of lateral walls 6A extending in the row direction in areas opposite the bus electrodes X1a and Y1a of each row electrode pair (X1, Y1), and vertical walls 6B extending between the pair of lateral walls 6A in the column direction in a mid-position between the adjacent column electrodes D. The partition wall units 6 are regularly arranged in the column direction in such a manner as to form an interstice SL extending in the row direction between back-to-back lateral walls 6A of adjacent partition wall units 6.

The ladder-shaped partition wall units 6 partition the discharge space S defined between the front glass substrate 1 and the back glass substrate 4 into quadrangular discharge cells C1 each corresponding to the paired transparent electrodes X1b, Y1b in each row electrode pair (X1, Y1).

Within each discharge cell C1, a phosphor layer 7 covers the five faces: the side faces of the lateral walls 6A and the vertical walls 6B of the partition wall unit 6 and the front-facing face of the column-electrode protective layer 5. The primary three colors, red, green and blue are applied individually to the phosphor layers 7, so that the red, green and blue discharge cells C1 are arranged in order in the row direction.

A portion of the protective layer 3 covering each additional dielectric layer 2A is in contact with the front-facing face of the lateral wall 6A of the partition wall unit 6 (see FIG. 3) to block a discharge cell C1 and an interstice SL from each other.

The discharge spaces is filled with a discharge gas including xenon (Xe).

As in the case of the conventional PDP, the foregoing PDP 10 produces a reset discharge simultaneously between all the paired transparent electrodes X1b and Y1b of the row electrode pairs (X1, Y1) in a reset discharge period, resulting in complete erasure of wall charge on a portion of the dielectric layer 2 adjoining each discharge cell C1 (or alternatively, deposition of wall charge on the portion of the dielectric layer 2 adjoining each discharge cell C1).

In the following address discharge period, an address discharge is produced selectively between the transparent electrode Y1b of the row electrode Y1 to which a scan pulse is applied and the column electrode D1 to which a data pulse is applied. The address discharge results in the distribution of the light-emitting cells with the deposition of the wall charge on the dielectric layer and the non-light-emitting cells which have had the wall charge erased from the dielectric layer 2, over the panel surface in accordance with the image data of the video signal.

In the following sustaining discharge period, a sustaining discharge is produced between the paired transparent electrodes X1b, Y1b of the row electrode pair (X, Y) in each of the light-emitting cells. The sustaining discharge results in the emission of vacuum ultraviolet light from the xenon included in the discharge gas. The vacuum ultraviolet light excites the red-, green- and blue-colored phosphor layers 7 to cause them to emit visible light for the generation of an image on the panel surface.

As described earlier, in the PDP 10 the opposing portions X1b2, Y1b2 of the transparent electrodes X1b, Y1b between which the sustaining discharge is produced face each other across the discharge gap g1 or g2 and are inclined at a predetermined angle θ1 relative to the row direction. Due to this inclination, the discharge-gap length (the length of the opposing area of the opposing portions X1b2 and Y1b2) x1 is increased with respect to the width of the discharge cell C1 in the row direction in correspondence with the degree of inclination.

Accordingly, in the PDP 10, for example, with the higher definition of the panel, the width of each discharge cell C1 in the row direction (the interval between the vertical walls 6B of the partition wall unit 6) is decreased, or alternatively the width h of the vertical wall 6B of the partition wall unit 6 (see FIG. 2) is increased as required. In consequence, even when the width of each discharge cell C1 in the row direction is decreased, it is possible to set the discharge-gap length x1 between the paired transparent electrodes X1b and Y1b at a length suitable for a reduction in the breakdown voltage for the sustaining discharge.

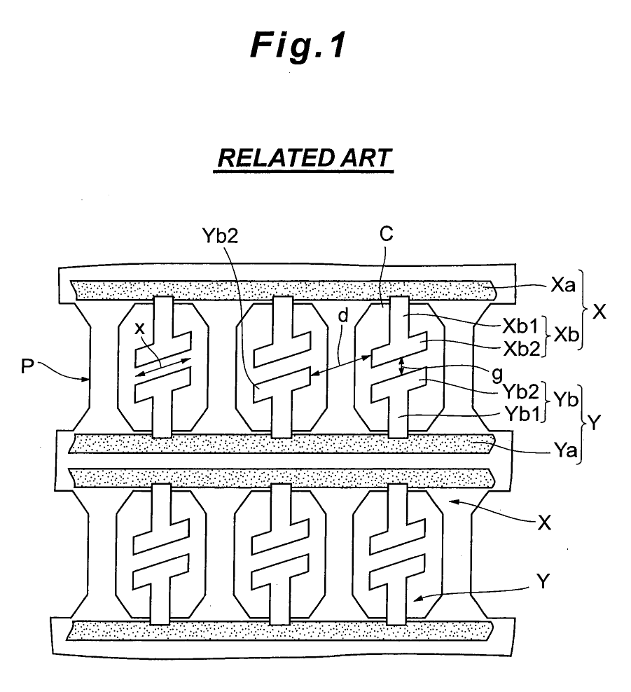

Regarding to the PDP 10, further, in each row electrode pair (X1, Y1), the transparent electrodes X_{R}1b, Y_{R}1b and the transparent electrodes X_{L}1b, Y_{L}1b alternate in position along the bus electrodes X1a, Y1a of the row electrodes X1, Y1, so that the inclinations of the opposing portions X_{R}1b2, Y_{R}1b2 of the transparent electrodes X_{R}1b, Y_{R}1b and the opposing portions X_{L}1b2, Y_{L}1b2 of the transparent electrodes X_{L}1b, Y_{L}1b which are respectively adjacent thereto are reversed in direction from each other. Thereby, the end of the opposing portion X_{R}1b2 of the transparent electrode X_{R}1b and the end of the opposing portion Y_{L}1b2 of the transparent electrode Y_{L}1b, which are adjacent to each other in the row direction, are out of alignment with each other where they face. Likewise, the end of the opposing portion Y_{R}1b2 of the transparent electrode Y_{R}1b and the end of the opposing portion X_{L}1b2 of the transparent electrode X_{L}1b, which are adjacent to each other in the row direction, are out of alignment with each other when they face. This allows the distances d1, d2 between the opposing portion X_{R}1b2 and the opposing portion Y_{L}1b2, the opposing portion Y_{R}1b2 and the opposing portion X_{L}1b2 to be set longer than those of the conventional PDP described in FIG. 1.

For this reason, even when the opposing portions X1b2, Y1b2 of the transparent electrodes X1b, Y1b are inclined relative to the row direction, the capacitance formed between the transparent electrodes X1b and Y1b respectively provided in the adjacent discharge cells C1 is lower than that in the conventional PDP described in FIG. 1. This enables a reduction in the consumption of reactive power caused by charging and discharging the capacitance between the row electrodes X1 and Y1.

In the first embodiment, the opposing portions X1b2, Y1b2 of the transparent electrodes X1b, Y1b may be formed in such a manner as to be alternately reversed in their inclining direction in each display line in the column direction.

The foregoing structure of the transparent electrodes X1b, Y1b of the row electrodes X1, Y1 can be applied similarly to a plasma display panel having the same arrangement of the row electrodes X1 and Y1 of a row electrode pair (X1, Y1) in each of the display lines L, in other words, the arrangement X1-Y1, X1-Y1, X1-Y1 in the column direction of the panel.

Further, the foregoing structure of the transparent electrodes X1b, Y1b of the row electrodes X1, Y1 can be similarly applied to a PDP of the type having both the row electrode pairs and the column electrodes formed on either the front glass substrate or the back glass substrate.

### Second Embodiment

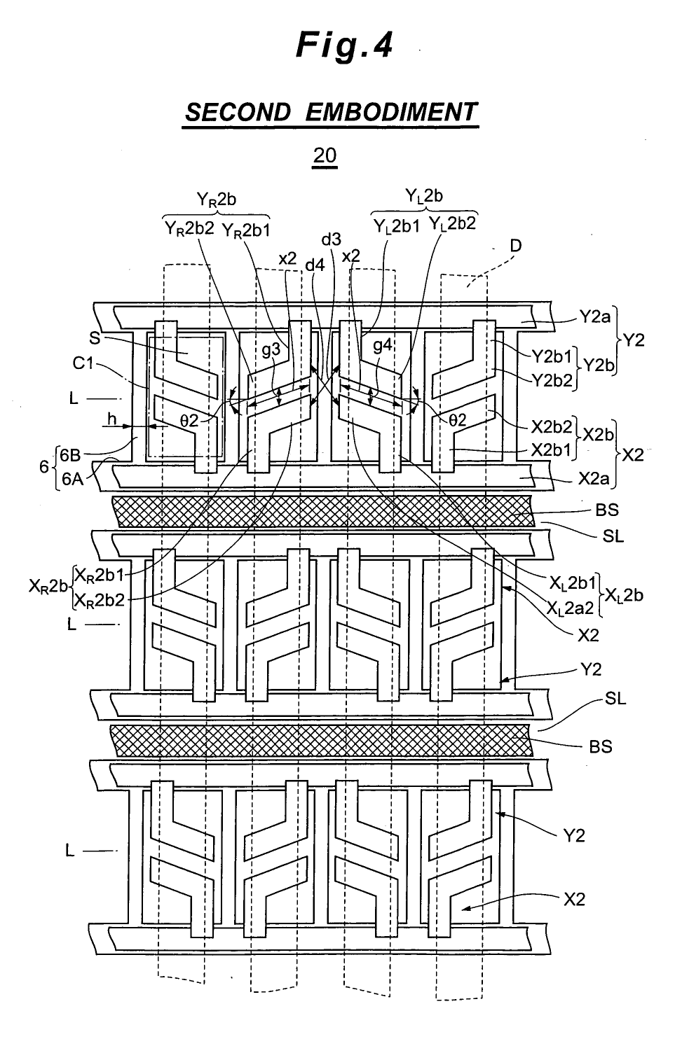

FIG. 4 is a schematic front view illustrating the structure of a second embodiment of the PDP according to the present invention.

The PDP 20 in the second embodiment is approximately the same as the PDP 10 in the first embodiment, except that the transparent electrodes X2b, Y2b formed along the corresponding bus electrodes X2a, Y2a of the row electrodes X2, Y2 constituting a row electrode pair (X2, Y2) differ in shape from the transparent electrodes X1b, Y1b of the row electrodes X1, Y1 described in the first embodiment. In FIG. 4, about the same component as the first embodiment, the same reference numerals as FIG. 2 are attached.

In FIG. 4, the row electrode X2 of the PDP 20 is structured such that two types of transparent electrodes X2b are lined up in alternate positions along a bus electrode X2a. The two types of transparent electrodes X2b are a transparent electrode X_{R}2b and a transparent electrode X_{L}2b. The transparent electrode X_{R}2b is formed in an approximate L shape made up of a base end X_{R}2b1 extending in the column direction and an opposing portion X_{R}2b2 extending out from the leading end of the base end X_{R}2b1 in a direction inclining at a predetermined angle θ2 in the right-hand direction with respect to the column direction (the clockwise direction). The transparent electrode X_{L}2b is formed in an approximate L shape reversed in direction from the transparent electrode X_{R}2b and made up of a base end X_{L}2b1 extending in the column direction and an opposing portion X_{L}2b2 extending out from the leading end of the base end X_{L}2b1 in a direction inclining in the left-hand direction with respect to the column direction (the counterclockwise direction).

The base end X_{R}2b1 of the transparent electrode X_{R}2b is connected to a portion of the bus electrode X2a to the left in FIG. 4 rather than in the center of the portion of the bus electrode X2a corresponding to each discharge cell C1. The base end X_{L}2b1 of the transparent electrode X_{L}2b is connected to a portion of the bus electrode X2a to the right in FIG. 4 rather than in the center of the portion of the bus electrode X2a corresponding to each discharge cell C1. (In other words, the base ends X_{R}2b1 and X_{L}2b1 of the respective transparent electrodes X_{R}2b and X_{L}2b positioned back to back with each other are close to each other on either side of the vertical wall 6B of the partition wall unit 6.)

Likewise, the row electrode Y2 of the PDP 20 is structured such that two types of transparent electrodes Y2b, namely a transparent electrode Y_{R}2b and a transparent electrode Y_{L}2b, are lined up in alternate positions along a bus electrode Y2a. The transparent electrode Y_{R}2b is formed in an approximate inverted-L shape made up of a base end Y_{R}2b1 extending in the column direction and an opposing portion Y_{R}2b2 extending out from the leading end of the base end Y_{R}2b1 in a direction inclining in the right-hand direction with respect to the column direction. The transparent electrode Y_{L}2b is formed in an approximately L shape made up of a base end Y_{L}2b1 extending in the column direction and an opposing portion Y_{L}2b2 extending out from the leading end of the base end Y_{L}2b1 in a direction inclining in the left-hand direction.

The base end Y_{R}2b1 of the transparent electrode Y_{R}2b is connected to a portion of the bus electrode Y2a to the right in FIG. 4 rather than in the center of the portion of the bus electrode Y2a corresponding to each discharge cell C1. The base end Y_{L}2b1 of the transparent electrode Y_{L}2b is connected to a portion of the bus electrode Y2a to the left in FIG. 4 rather than in the center of the portion of the bus electrode Y2a corresponding to each discharge cell C1. (In other words, the base ends Y_{R}2b1 and Y_{L}2b1 of the respective transparent electrodes Y_{R}2b and Y_{L}2b positioned back to back with each other are close to each other on either side of the vertical wall 6B of the partition wall unit 6.)

The transparent electrode X2b simply described hereinafter includes both the transparent electrodes X_{R}2b and X_{L}2b, and the transparent electrode Y2b includes both the transparent electrodes Y_{R}2b and Y_{L}2b.

The transparent electrodes X2b, Y2b in the row electrodes X2, Y2 have the transparent electrodes X_{R}2b and Y_{R}2b paired with each other and the transparent electrodes X_{L}2b and Y_{L}2b paired with each other. The opposing portion X_{R}2b2 of the transparent electrode X_{R}2b and the opposing portion Y_{R}2b2 of the transparent electrode Y_{R}2b face each other in parallel across a discharge gap g3. The opposing portion X_{L}2b2 of the transparent electrode X_{L}2b and the opposing portion Y_{L}2b2 of the transparent electrode Y_{L}2b face each other in parallel across a discharge gap g4.

As described earlier, in the PDP 20 the opposing portions X2b and Y2b of the transparent electrodes X2b, Y2b for producing a sustaining discharge face each other across the gap g3 or g4 and are inclined at a predetermined angle θ2 relative to the column direction. Therefore, the discharge-gap length (the length of the opposing area of the opposing portions X2b2 and Y2b2) x2 is increased with respect to the width of the discharge cell C1 in the row direction in correspondence with the degree of inclination.

Accordingly, in the PDP 20, for example, with the higher definition of the panel, the with of the each discharge cell C1 in the row direction (the interval between the vertical walls 6B of the partition wall unit 6) is decreased, or alternatively, the width h of the vertical wall 6B of the partition wall unit 6 (see FIG. 4) is increased as required. In consequence, even when the width of each discharge cell C1 in the row direction is decreased, it is possible to set the discharge-gap length x2 between the paired transparent electrodes X2b and Y2b at a length suitable for a reduction in the break down voltage for the sustaining discharge.

Regarding to the PDP 20, further, in each row electrode pair (X2, Y2) the transparent electrodes X_{R}2b, Y_{R}2b and the transparent electrodes X_{L}2b, Y_{L}2b alternate in position along the bus electrodes X2a, Y2a of the row electrodes X2, Y2. Hence, the opposing portions X_{R}2b2, Y_{R}2b2 of the transparent electrodes X_{R}2b, Y_{R}2b and the opposing portions X_{L}2b2, Y_{L}2b2 of the transparent electrodes X_{L}1b, Y_{L}1b respectively adjacent to the opposing portions X_{R}2b2, Y_{R}2b2 are out of alignment where they face. The distance d3 between the opposing portion X_{R}2b2 of the transparent electrode X_{R}2b and the opposing portion Y_{L}2b2 of the transparent electrode Y_{L}2b adjacent thereto, and the distance d4 between the opposing portion X_{L}2b2 of the transparent electrode X_{L}2b and the opposing portion Y_{R}2b2 of the transparent electrode Y_{R}2b adjacent thereto, are set longer than those of the conventional PDP described in FIG. 1.

For this reason, even when the opposing portions X2b2, Y2b2 of the transparent electrodes X2b, Y2b are inclined relative to the row direction, the capacitance between the transparent electrodes X2b and Y2b respectively provided in the adjacent discharge cells C1 is lower than that in the conventional PDP described in FIG. 1. This enables a reduction in the consumption of reactive power caused by charging and discharging the capacitance between the row electrodes X2 and Y2.

Further, in the PDP 20 the transparent electrodes X2b, Y2b are formed in an approximate L shape, and the base ends X2b1, Y2b1 of the transparent electrodes X2b, Y2b are connected to the ends of the opposing portions X2b2, Y2b2 located closer to the associated bus electrodes X2a, Y2a. This enables a decrease in the length of each of the base ends X2b1, Y2b1 as compared with that in the first embodiment in which the base end is connected to an approximately central portion of the opposing portion. This reduces the capacitance between the row electrodes X2 and Y2, leading to a reduction in consumption of reactive power.

In the second embodiment, the opposing portions X2b2, Y2b2 of the transparent electrodes X2b, Y2b may be formed in such a manner as to be alternately reversed in their inclining direction in each display line in the column direction.

As in the case of the first embodiment, the foregoing structure of the transparent electrodes X2b, Y2b of the row electrodes X2, Y2 can be applied similarly to a plasma display panel having the same arrangement of the row electrodes X2 and Y2 of a row electrode pair (X2, Y2) in each of the display lines L, in other words, the alternating arrangement X2-Y2, X2-Y2, X2-Y2 in the column direction of the panel.

Further, the foregoing structure of the transparent electrodes X2b, Y2b of the row electrodes X2, Y2 can be similarly applied to a PDP of the type having both the row electrode pairs and the column electrodes formed on either the front glass substrate or the back glass substrate.

### Third Embodiment

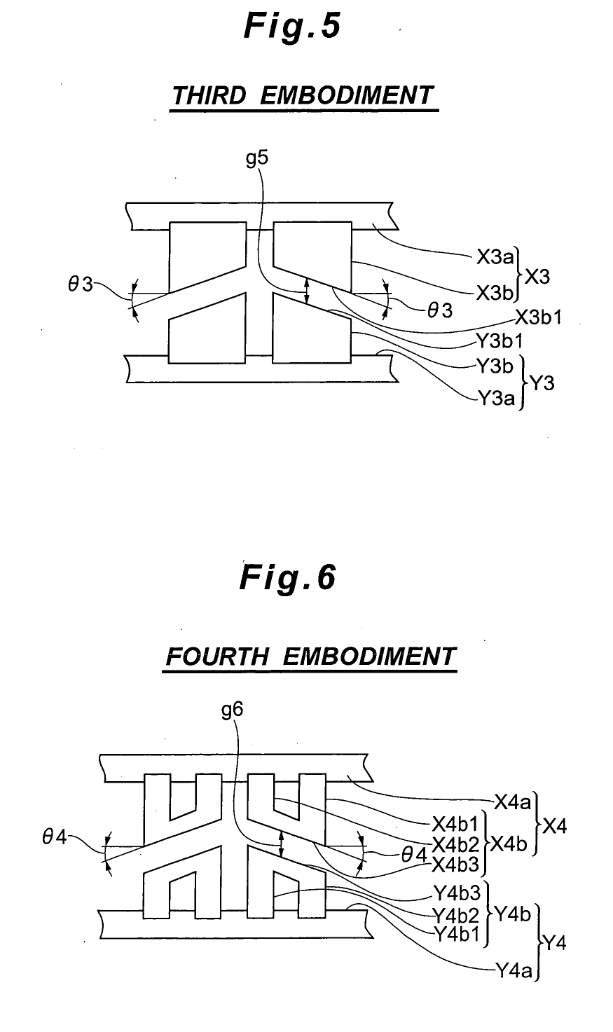

FIG. 5 is a front view illustrating the structure in a third embodiment of the PDP according to the present invention.

In the PDP in the third embodiment, transparent electrodes X3b, Y3b of row electrodes X3, Y3 in each row electrode pair have a broad, constant width and extend out from the bus electrodes X3a, Y3a toward their counterpart row electrodes Y3, X3. The transparent electrodes X3b, Y3b respectively have opposing portions X3b1, Y3b1 facing each other across a discharge gap g5. The opposing portions X3b1, Y3b1 are inclined at a predetermined angle θ3 in alternately opposite directions along the bus electrodes X3a, Y3a relative to the row direction.

As in the cases of the first and second embodiments, in the PDP of the third embodiment, the distance between an opposing portion of a transparent electrode in a transparent electrode pair and an opposing portion of a transparent electrode adjacent to the other transparent electrode in the transparent electrode pair in the row direction is increased. Further, the ends of the transparent electrodes which are located in the adjacent discharge cells and to which different voltages are applied do not face each other.

This reduces the capacitance between the transparent electrodes located in the adjacent discharge cells, resulting in a reduction in the consumption of reactive power caused by charging and discharging the capacitance between the row electrodes.

### Fourth Embodiment

FIG. 6 is a front view illustrating the structure of a fourth embodiment of the PDP according to the present invention.

In the PDP in the fourth embodiment, each of the transparent electrodes X4b, Y4b in row electrodes X4, Y4 is composed of two base ends X4b1 and X4b2 (Y4b1 and Y4b2) being different in length from each other and connected to the bus electrode X3a (Y3a), and an opposing portion X4b3 (Y4b3) formed integrally with and between the base ends X4b1 and X4b2 (Y4b1 and Y4b2) in bridge form. The opposing portions X4b3 and Y4b3 face each other across a discharge gap g6, and are inclined at a predetermined angle θ4 in alternately opposite directions along the bus electrodes X4a, Y4a relative to the row direction.

As in the cases of the first to third embodiments, in the PDP of the fourth embodiment, the distance between an opposing portion of a transparent electrode in a transparent electrode pair and an opposing portion of a transparent electrode adjacent to the other transparent electrode in the transparent electrode pair in the row direction is increased. Further, the ends of the transparent electrodes which are located in the adjacent discharge cells and to which different voltages are applied do not face each other.

This reduces the capacitance between the transparent electrodes located in the adjacent discharge cells, resulting in a reduction in the consumption of reactive power caused by charging and discharging the capacitance between the row electrodes.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel having a pair of substrates facing each other across a discharge space, comprising:
a plurality of row electrode pairs each extending in a row direction and regularly arranged in a column direction on one of the pair of substrates;
a plurality of column electrodes each extending in the column direction and regularly arranged in the row direction on either one or the other substrate in the pair of substrates; and
unit light emitting areas formed in portions of the discharge space corresponding to intersections between the column electrodes and the row electrode pairs,
each of row electrodes constituting the pair of row electrodes comprising:
an electrode body extending in the row direction; and
electrode projecting portions each extending out from the electrode body toward its counterpart row electrode, to face the electrode projecting portion of its counterpart row electrode across a discharge gap in each unit light emitting area,
wherein each of the paired electrode projecting portions facing each other has a portion facing the other electrode projecting portion in the pair with the discharge gap in between, and the portion is inclined at a predetermined angle in either the clockwise direction or the counterclockwise direction relative to the row direction of the panel,
the electrode projecting portions each having the portion facing the other electrode projecting portion in the pair and inclined in the clockwise direction, and the electrode projecting portions each having the portion inclined in the counterclockwise direction are placed in alternate positions along the associated electrode bodies, and the electrode projecting portions of one row electrode and the other row electrode in each row electrode pair are inclined in the same direction and face each other across the discharge gap.

2. A plasma display panel according to claim 1, wherein each of the electrode projecting portions paired with each other are composed of a base end portion which is connected to the associated electrode body and extends out from the electrode body toward its counterpart electrode projecting portions in the pair in the column direction, and the opposing portion which is formed integrally with a leading end of the base end portion with being inclined at the predetermined angle in either the clockwise direction or the counterclockwise direction relative to the row direction of the panel, and faces its counterpart electrode projecting portion in the pair with the discharge gap in between.

3. A plasma display panel according to claim 2, wherein each of the opposing portions of the electrode projecting portions has a width in the row direction larger than that of the base end portion, and each of the leading ends of the base ends portion is connected to an approximate center of the associated opposing portion.

4. A plasma display panel according to claim 2, wherein each of the leading ends of the base end portions of the electrode projecting portions is connected to an end portion of the opposing portion located close to the associated electrode body.

5. A plasma display panel according to claim 4, wherein each of the base end portions of the electrode projecting portions in each unit light emitting area is connected to the associated electrode body in a position close to a dividing line from an adjacent unit light emitting area which is located apart from the direction in which the opposing portion extends, rather than a central portion of a portion of the electrode body corresponding to the unit light emitting area.
